(19) United States
(12) Patent Application Publication
(10) Pub. No.: US 2019/0063653 A1
(43) Pub. Date: Feb. 28, 2019

(54) RETENTION SYSTEM FOR A HOSE RECEIVER

(71) Applicant: CNH Industrial Canada, Ltd., Saskatoon (CA)

(72) Inventor: Graham Douglas Stuart, Warman (CA)

(73) Assignee: CNH Industrial Canada, Ltd.

(21) Appl. No.: 15/692,652

(22) Filed: Aug. 31, 2017

(51) Int. Cl. F16L 37/091

(52) U.S. Cl. CPC F16L 37/091; F16L 37/086

(57) ABSTRACT

A hose receiver includes a housing having a longitudinal conduit and a radial aperture extending through the longitudinal conduit. The longitudinal conduit is configured to receive a hose, and the radial aperture is positioned to align with the hose while the hose is disposed within the longitudinal conduit. The hose receiver also includes a retention system having a retaining feature. The retaining feature is movably coupled to the longitudinal conduit and configured to move within the radial aperture, the retaining feature is configured to engage the hose in response to a radially inward force applied to the retaining feature, and the retaining feature is configured to block movement of the hose relative to the housing while engaged.

### BACKGROUND

The disclosure relates generally to a retention system for a hose receiver.

A seeding implement may be towed behind a tractor or other work vehicle via a hitch assembly. The seeding implement may include multiple row units distributed across a width of the seeding implement. Each row unit may include an opener configured to form a respective seeding path for seed deposition into the soil. The opener is used to break the soil, and a seed tube positioned behind the opener is configured to deposit seeds into the soil. After the seeds are deposited, a closing wheel, which is positioned behind the seed tube, redirects the soil onto the deposited seeds.

In certain configurations, a product distribution system is used to meter and deliver product (e.g., seed, fertilizer, etc.) to the row units of the seeding implement. Certain product distribution systems include a metering system configured to deliver metered quantities of product into an airflow that transfers the product to the row units. For example, primary distribution lines may extend from the metering system to flow dividers that distribute the product to two secondary distribution lines. Each secondary distribution line may be coupled to a respective row unit, thereby establishing a flow path from the metering system to the row units.

The flow dividers may also be utilized to control the flow of product to the row units. For example, if the row units are spaced 7.5 inches from one another, and 15 inch row spacing is desired, the flow dividers may block product flow to alternating row units. To enable each flow divider to control the flow of product to the row units, a primary distribution line may be coupled to an inlet conduit of the flow divider, and secondary distribution lines may be coupled to outlet conduits of the flow divider. The lines may be coupled to the conduits by respective hose clamps that compress the conduits around the lines.

### BRIEF DESCRIPTION

In one embodiment, a hose receiver includes a housing having a longitudinal conduit and a radial aperture extending through the longitudinal conduit. The longitudinal conduit is configured to receive a hose, and the radial aperture is positioned to align with the hose while the hose is disposed within the longitudinal conduit. The hose receiver also includes a retention system having a retaining feature. The retaining feature is movably coupled to the longitudinal conduit and configured to move within the radial aperture, the retaining feature is configured to engage the hose in response to a radially inward force applied to the retaining feature, and the retaining feature is configured to block movement of the hose relative to the housing while engaged.

In another embodiment, a flow divider assembly includes a housing having an inlet conduit configured to receive an agricultural product, a first outlet conduit configured to discharge the agricultural product, and a second outlet conduit configured to discharge the agricultural product. Each of the inlet conduit, the first outlet conduit, and the second outlet conduit is configured to receive a respective hose. The flow divider assembly also includes a valve disposed within the housing. The valve is configured to selectively direct the agricultural product from the inlet conduit to the first outlet conduit, to the second outlet conduit, or a combination thereof. In addition, the flow divider assembly includes a retaining system having a retaining feature. At least one conduit of the inlet conduit, the first outlet conduit, and the second outlet conduit has a respective radial aperture extending through the conduit, the respective radial aperture is positioned to align with the respective hose while the respective hose is disposed within the conduit, the retaining feature is movably coupled to the conduit and is configured to move within the respective radial aperture of the conduit, the retaining feature is configured to engage the respective hose in response to a radially inward force applied to the retaining feature, and the retaining feature is configured to block movement of the respective hose relative to the housing while engaged.

In a further embodiment, a method of manufacturing a hose receiver includes forming a housing having a longitudinal conduit and a radial aperture extending through the longitudinal conduit. The longitudinal conduit is configured to receive a hose, and the radial aperture is positioned to align with the hose while the hose is disposed within the longitudinal conduit. The method also includes forming a retaining feature of a retention system. The retaining feature is movably coupled to the longitudinal conduit and configured to move within the radial aperture, the retaining feature is configured to engage the hose in response to a radially inward force applied to the retaining feature, and the retaining feature is configured to block movement of the hose relative to the housing while engaged.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an agricultural implement that includes a product distribution system;

FIG. 2 is a top view of an embodiment of a flow divider assembly that may be employed within the product distribution system of FIG. 1;

FIG. 3 is a perspective view of an inlet conduit of the flow divider assembly of FIG. 2;

FIG. 4 is a side view of the inlet conduit of the flow divider assembly of FIG. 2;

FIG. 5 is a perspective view of an inlet conduit of another embodiment of a flow divider assembly that may be employed within the product distribution system of FIG. 1; and

FIG. 6 is a side view of the inlet conduit of the flow divider assembly of FIG. 5.

### DETAILED DESCRIPTION

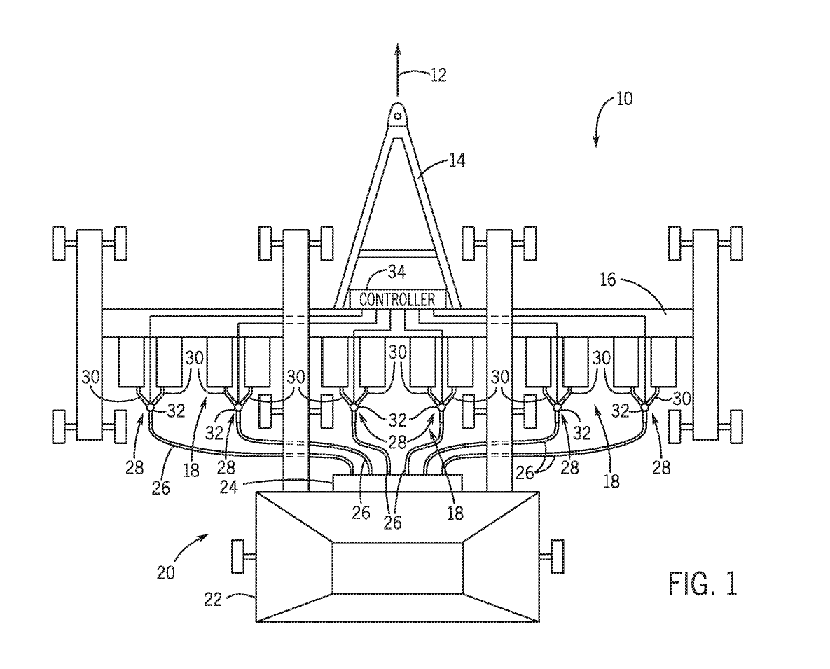

FIG. 1 is a schematic diagram of an embodiment of an agricultural implement 10 that includes a product distribution system. In the illustrated embodiment, the implement 10 is configured to be towed along a direction of travel 12 by a work vehicle, such as a tractor or other prime mover. The work vehicle may be coupled to the implement 10 by a hitch assembly, such as the illustrated A-frame 14. As illustrated, the implement 10 includes a tool bar 16, and row units 18 coupled to the tool bar 16. Each row unit 18 is configured to excavate a trench into soil and to deposit seed and/or fertilizer into the trench. While the implement 10 includes a single tool bar 16 in the illustrated embodiment, alternative embodiments may include additional tool bars 16, each having multiple row units 18. Furthermore, while the illustrated implement includes twelve row units 18, alternative implements may include more or fewer row units 18.

In the illustrated embodiment, the implement 10 includes a product distribution system 20 configured to transfer product from a storage tank 22 to the row units 18. In certain configurations, the storage tank 22 includes multiple compartments for storing various flowable particulate materials. For example, one compartment may include seeds, and another compartment may include a dry/granular fertilizer. In such configurations, the product distribution system 20 may be configured to deliver both seed and fertilizer to the row units 18 via separate distribution lines, or as a mixture of seed and fertilizer through a single set of lines.

During operation, seed and/or fertilizer within the storage tank 22 are gravity fed into a metering system 24, thereby enabling the metering system to distribute a target flow rate of product to the row units 18. For example, the metering system 24 may include sectioned meter rollers to control the flow of product from the storage tank 22 into an air flow provided by an air source. In such a configuration, the air flow carries the product through distribution lines, thereby supplying the row units 18 with seed and/or fertilizer for deposition into the soil. In the illustrated embodiment, the product distribution system 20 includes primary distribution lines 26, flow divider assemblies 28, and secondary distribution lines 30 to facilitate product distribution from the metering system 24 to the row units 18. As illustrated, six primary distribution lines 26 extend from the metering system 24 to the flow divider assemblies 28. Each flow divider assembly 28 splits the flow of product into two secondary distribution lines 30, which convey the product to respective row units 18. The number of primary distribution lines 26 may be particularly selected based on the number of row units 18. By way of example, if an implement 10 includes sixty-four row units 18, thirty-two primary distribution lines 26 may be employed to convey product to the row units 18. While each flow divider assembly is configured to split the flow of product into two secondary distribution lines in the illustrated embodiment, in other embodiments, at least one flow divider assembly may be configured to split the flow of product into three or more secondary distribution lines.

In the illustrated embodiment, each flow divider assembly 28 is configured to selectively control product flow to a respective pair of row units, thereby enabling an operator to control row spacing. For example, if the row units 18 are separated from one another by 7.5 inches, and 15 inch row spacing is desired, each flow divider assembly 28 may block flow to one of the respective row units 18. As a result, the product distribution system 20 flows product to alternating row units 18, thereby establishing the desired row spacing.

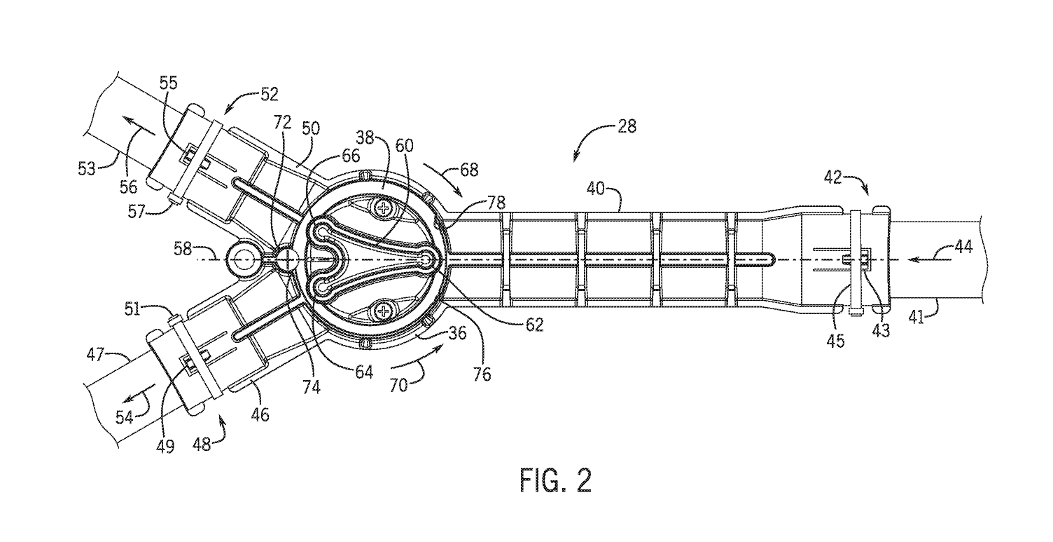

Each flow divider assembly 28 includes a housing having an inlet conduit configured to receive product from a respective primary distribution line 26, and two outlet conduits configured to discharge the product to two respective secondary distribution lines 30. The flow divider assembly 28 also includes a valve disposed within the housing. The valve is configured to selectively facilitate flow of the product from the inlet conduit to each outlet conduit, and to facilitate flow of the product from the inlet conduit to one outlet conduit while substantially blocking flow of the product from the inlet conduit to the other outlet conduit (e.g., via rotation of the valve). In the illustrated embodiment, each flow divider assembly 28 includes an actuator 32 (e.g., an electric stepper motor, a hydraulic/pneumatic rotary actuator, a linear actuator, a mechanical actuator, etc.) configured to drive the valve in rotation, thereby controlling product flow to each row unit. As illustrated, each actuator 32 is communicatively coupled to a controller 34 (e.g., via a CAN bus), thereby enabling the controller 34 to adjust row spacing via actuation of each valve. For example, if the row units 18 are spaced 7.5 inches from one another, and 7.5 inch row spacing is desired, the controller 34 may instruct each actuator 32 to rotate the respective valve to a position that facilitates product flow to each row unit 18. Furthermore, if 15 inch row spacing is desired, the controller 34 may instruct each actuator 32 to rotate the respective valve to a position that facilitates product flow to one row unit 18 while blocking product flow to the other row unit 18. In this configuration, an operator may control row spacing from a control panel communicatively coupled to the controller 34, and/or row spacing may be automatically adjusted based on a detected position of the implement (e.g., via a spatial locating system receiver). In further embodiments, such as the embodiment disclosed below with reference to FIG. 2, the valve of the flow divider assembly may be manually controlled. In such embodiments, the controller and/or the actuators may be omitted.

As discussed in detail below, at least one of the conduits of the flow divider assembly housing may include a radial aperture extending through the conduit. The radial aperture is configured to align with a hose (e.g., the primary distribution line or the secondary distribution line) while the hose is disposed within the conduit. The flow divider assembly may also include a retention system having a retaining feature. The retaining feature is movably coupled to the conduit and configured to move within the radial aperture. In addition, the retaining feature is configured to engage the hose in response to a radially inward force applied to the retaining feature, and the retaining feature is configured to block movement of the hose relative to the housing while engaged. Because the retention system employs a movable retaining feature to engage the hose, the longevity of the housing may be increased (e.g., as compared to a housing that utilizes a compressible conduit end to couple the hose to the conduit). While the flow divider assemblies are employed within an agricultural implement in the illustrated embodiment, in other embodiments, the flow divider assemblies may be utilized within other systems, such as a product distribution system of an air cart, an air distribution system of a harvester, or any other suitable system that may utilize flow divider assemblies to control flow of a fluid (e.g., air, liquid, powder, particulate material, etc.). In addition, while the retention system disclosed herein is described with reference to a flow divider assembly, in further embodiments, the retention system may be utilized to couple a hose to other suitable hose receivers, such as a hose receiver of the metering system, a hose receiver of an air cart plenum, or any other suitable hose receiver.

FIG. 2 is a top view of an embodiment of a flow divider assembly 28 that may be employed within the product distribution system of FIG. 1. As illustrated, the flow divider assembly 28 includes a housing 36 and a valve 38 disposed within the housing 36. The housing 36 includes an inlet conduit 40 (e.g., longitudinal conduit) configured to receive product from a primary distribution line 41 (e.g., respective hose). In the illustrated embodiment, the inlet conduit 40 is configured to connect to the primary distribution line 41 via a retention system 42, thereby facilitating product flow into the flow divider assembly 28 along a longitudinal axis/direction 44. The retention system 42 includes a retaining feature 43 configured to move within a radial aperture of the inlet conduit 40. The retaining feature 43 is configured to engage the primary distribution line 41 in response to a radially inward force applied to the retaining feature 43 (e.g., by the hose clamp 45). The retaining feature 43 is configured to block movement of the primary distribution line 41 relative to the housing 36 while engaged, thereby coupling the primary distribution line 41 to the inlet conduit 40. While a hose clamp 45 is utilized to apply the radially inward force to the retaining feature 43 in the illustrated embodiment, in alternative embodiments, another connector (e.g., cable tie, elastic connector, etc.) may be utilized to apply the radially inward force.

The housing 36 also includes a first outlet conduit 46 (e.g., longitudinal conduit) configured to discharge product to a respective secondary distribution line 47 (e.g., respective hose). In the illustrated embodiment, the first outlet conduit 46 is configured to connect to the respective secondary distribution line via a retention system 48, thereby facilitating product flow from the flow divider assembly 28 to a respective row unit. As illustrated, the first outlet conduit 46 is configured to discharge the product in a longitudinal direction 54. The retention system 48 includes a retaining feature 49 configured to move within a radial aperture of the first outlet conduit 46. The retaining feature 49 is configured to engage the respective secondary distribution line 47 in response to a radially inward force applied to the retaining feature 49 (e.g., by the hose clamp 51). The retaining feature 49 is configured to block movement of the respective secondary distribution line 47 relative to the housing 36 while engaged, thereby coupling the respective secondary distribution line 47 to the first outlet conduit 46. While a hose clamp 51 is utilized to apply the radially inward force to the retaining feature 49 in the illustrated embodiment, in alternative embodiments, another connector (e.g., cable tie, elastic connector, etc.) may be utilized to apply the radially inward force.

In addition, the housing 36 includes a second outlet conduit 50 (e.g., longitudinal conduit) configured to discharge product to another respective secondary distribution line 53 (e.g., respective hose). In the illustrated embodiment, the second outlet conduit 50 is configured to connect to the respective secondary distribution line via a retention system 52, thereby facilitating product flow from the flow divider assembly 28 to a respective row unit. As illustrated, the second outlet conduit 50 is configured to discharge the product in a longitudinal direction 56. The retention system 52 includes a retaining feature 55 configured to move within a radial aperture of the second outlet conduit 50. The retaining feature 55 is configured to engage the respective secondary distribution line 53 in response to a radially inward force applied to the retaining feature 55 (e.g., by the hose clamp 57). The retaining feature 55 is configured to block movement of the respective secondary distribution line 53 relative to the housing 36 while engaged, thereby coupling the respective secondary distribution line 53 to the second outlet conduit 50. While a hose clamp 57 is utilized to apply the radially inward force to the retaining feature 55 in the illustrated embodiment, in alternative embodiments, another connector (e.g., cable tie, elastic connector, etc.) may be utilized to apply the radially inward force. While the illustrated flow divider assembly includes three retention systems to couple a respective hose to each conduit, in alternative embodiments, the flow divider assembly may employ fewer retention systems (e.g., to couple a respective hose to one or two conduits of the flow divider assembly).

In the illustrated embodiment, the valve 38 is configured to rotate about an axis substantially perpendicular to a longitudinal centerline 58 of the housing 36. The valve 38 is selectively rotatable between a first position that facilitates product flow from the inlet conduit 40 to the first and second outlet conduits 46 and 50, a second position that facilitates product flow from the inlet conduit 40 to the first outlet conduit 46, and substantially blocks product flow from the inlet conduit 40 to the second outlet conduit 50, and a third position that facilitates product flow from the inlet conduit 40 to the second outlet conduit 50, and substantially blocks product flow from the inlet conduit 40 to the first outlet conduit 46. In certain embodiments, the valve 38 is also rotatable to a fourth position that substantially blocks product flow from the inlet conduit 40 to the first and second outlet conduits 46 and 50. In this configuration, product flow to each row unit may be selectively controlled via rotation of the valve 38 to a selected position.

In the illustrated embodiment, the valve 38 includes a handle 60 having multiple protrusions configured to provide a visual indication of valve position. As illustrated, the handle 60 is substantially triangular shaped, and includes a first protrusion 62, a second protrusion 64, and a third protrusion 66. With the valve oriented in the illustrated first position, the first protrusion 62 is aligned with the inlet conduit 40, the second protrusion 64 is aligned with the first outlet conduit 46, and the third protrusion 66 is aligned with the second outlet conduit 50. Accordingly, with the valve in the illustrated first position, the protrusions provide a visual indication that a flow path is established between the inlet conduit 40 and both outlet conduits 46 and 50.

An operator may transition the valve 38 to the second position by rotating the handle 60 in a clockwise direction 68 until the first protrusion 62 is aligned with the first outlet conduit 46. With the valve 38 in the second position, product flows to the first outlet conduit 46 alone. In addition, an operator may transition the valve 38 to the third position by rotating the handle 60 in a counterclockwise direction 70 until the first protrusion 62 is aligned with the second outlet conduit 50. With the valve 38 in the third position, product flows to the second outlet conduit 50 alone. Consequently, the handle 60 provides a visual indication of the product flow path through the flow divider assembly 28 via placement of the protrusions relative to the inlet/outlet passages.

In the illustrated embodiment, the flow divider assembly 28 includes a fastener 72 configured to secure the valve 38 to the housing 36. The fastener 72 is also configured to block rotation of the valve 38 while the fastener 72 is engaged with one of a series of notches disposed about a circumference of the valve 38. As illustrated, with the valve 38 in the illustrated first position, the fastener 72 is engaged with a first notch 74, thereby holding the valve 38 in the first position. To transition the valve 38 to the second position, the valve 38 may be rotated in the clockwise direction 68 to disengage the notch from the fastener. Rotation may continue until the first protrusion 62 aligns with the first outlet conduit 46. Once aligned, a second notch 76 engages the fastener 72, thereby holding the valve 38 in the second position. In addition, to transition the valve 38 from the first position to the third position, the valve 38 may be rotated in the counterclockwise direction 70 to disengage the notch from the fastener. Rotation may continue until the first protrusion 62 aligns with the second outlet conduit 50. Once aligned, a third notch 78 engages the fastener 72, thereby holding the valve 38 in the third position. In certain embodiments, the valve 38 may include a fourth notch configured to hold the valve in the fourth position that blocks product flow to both outlet conduits 46 and 50.

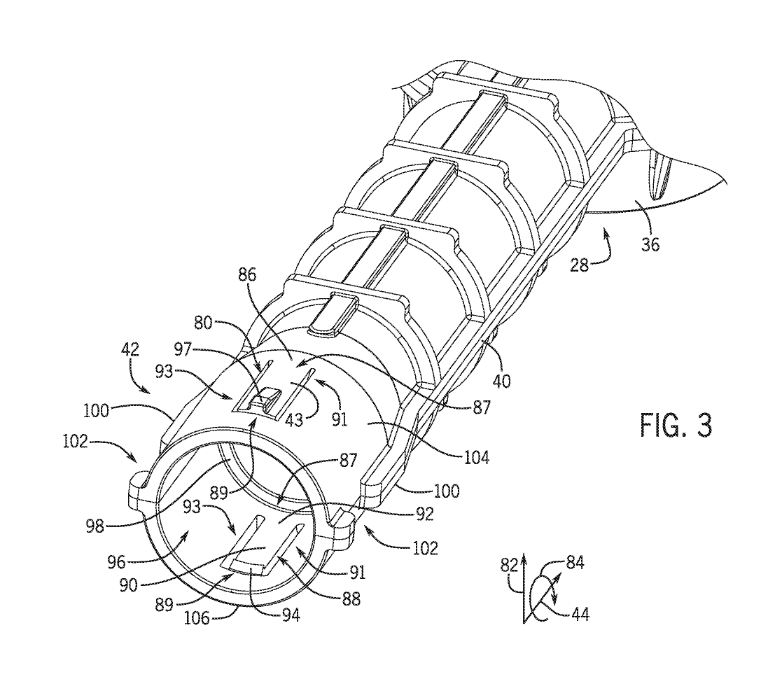

FIG. 3 is a perspective view of the inlet conduit 40 of the flow divider assembly 28 of FIG. 2. As illustrated, the housing 36 has a first radial aperture 80 extending through the inlet conduit 40 along a radial axis 82 of the inlet conduit 40. The first radial aperture 80 extends along the longitudinal axis 44 and along a circumferential axis 84. In addition, the first radial aperture 80 is positioned to align with the respective hose while the respective hose is disposed within the inlet conduit 40. In the illustrated embodiment, the retention system 42 includes a first retaining feature 43 movably coupled to the inlet conduit 40 and configured to move within the first radial aperture 80. The retaining feature 43 is configured to engage the respective hose in response to a radially inward force applied to the retaining feature 43 (e.g., force applied to the retaining feature 43 along the radial axis 82 toward the respective hose). In addition, the retaining feature 43 is configured to block movement of the respective hose relative to the housing 36 while engaged.

In the illustrated embodiment, the first retaining feature 43 is movably coupled to the inlet conduit 40 by a living hinge 86. The living hinge 86 is configured to enable the first retaining feature 43 to move (e.g., rotate about the circumferential axis 84) between the illustrated receiving position that enables the respective hose to be inserted into the inlet conduit 40 and a locking position, in which the retaining feature 43 is engaged with the respective hose, that blocks movement of the respective hose relative to the housing 36. While the illustrated living hinge 86 is positioned at a first longitudinal end 87 of the retaining feature 43 (e.g., first end of the retaining feature 43 along the longitudinal axis 44), in alternative embodiments, the living hinge may be positioned at a second longitudinal end 89 of the retaining feature, opposite the first longitudinal end 87, at a first circumferential end 91 of the retaining feature, at a second circumferential end 93 of the retaining feature, opposite the first circumferential end 91, or at any other suitable location on the retaining feature. In addition, while the thickness of the living hinge 86 (e.g., extent of the living hinge 86 along the radial axis 82) is substantially equal to the thickness of the first retaining feature 43 (e.g., extent of the first retaining feature 43 along the radial axis 82) in the illustrated embodiment, in other embodiments, the thickness of the living hinge may be greater or less than the thickness of the retaining feature. Furthermore, in certain embodiments, the retaining feature may be coupled to the inlet conduit by another suitable type of connector, such as a hinge, a rail, or a pivot, among other suitable types of connectors that facilitate movement of the retaining feature relative to the inlet conduit.

In the illustrated embodiment, the housing 36 has a second radial aperture 88 extending through the inlet conduit 40 along the radial axis 82. The second radial aperture 88 extends along the longitudinal axis 44 and along the circumferential axis 84. In addition, the second radial aperture 88 is positioned about 180 degrees from the first radial aperture 80 along the circumferential axis 84, and the second radial aperture 88 is positioned to align with the respective hose while the respective hose is disposed within the inlet conduit 40. In the illustrated embodiment, the retention system 42 includes a second retaining feature 90 movably coupled to the inlet conduit 40 and configured to move within the second radial aperture 88. The second retaining feature 90 is configured to engage the respective hose in response to a radially inward force applied to the second retaining feature 90 (e.g., force applied to the second retaining feature 90 along the radial axis 82 toward the respective hose). In addition, the second retaining feature 90 is configured to block movement of the respective hose relative to the housing 36 while engaged.

In the illustrated embodiment, the second retaining feature 90 is movably coupled to the inlet conduit 40 by a living hinge 92. The living hinge 92 is configured to enable the second retaining feature 90 to move (e.g., rotate about the circumferential axis 84) between the illustrated receiving position that enables the respective hose to be inserted into the inlet conduit 40 and a locking position, in which the second retaining feature 90 is engaged with the respective hose, that blocks movement of the respective hose relative to the housing 36. While the illustrated living hinge 92 is positioned at the first longitudinal end 87 of the second retaining feature 90 (e.g., first end of the second retaining feature 90 along the longitudinal axis 44), in alternative embodiments, the living hinge may be positioned at the second longitudinal end 89 of the second retaining feature, at the first circumferential end 91 of the second retaining feature, at the second circumferential end 93 of the second retaining feature, or at any other suitable location on the second retaining feature. In addition, while the thickness of the living hinge 92 (e.g., extent of the living hinge 92 along the radial axis 82) is substantially equal to the thickness of the second retaining feature 90 (e.g., extent of the second retaining feature 90 along the radial axis 82) in the illustrated embodiment, in other embodiments, the thickness of the living hinge may be greater or less than the thickness of the retaining feature. Furthermore, in certain embodiments, the second retaining feature may be coupled to the inlet conduit by another suitable type of connector, such as a hinge, a rail, or a pivot, among other suitable types of connectors that facilitate movement of the retaining feature relative to the inlet conduit.

In the illustrated embodiment, each retaining feature includes an engagement element, such as the illustrated angled tooth 94, configured to depress the hose while the respective retaining feature is engaged. Each angled tooth 94 includes an angled surface configured to facilitate insertion of the respective hose into the inlet conduit 40. In addition, each angled tooth 94 includes a substantially flat surface that extends to the angled surface, thereby forming a peak. The peak is configured to engage the respective hose to couple the respective hose to the inlet conduit 40 while the respective retaining feature is engaged (e.g., while the respective retaining feature is in the locking position). While the illustrated angled tooth 94 includes the angled surface and the substantially flat surface, in alternative embodiments, the tooth may include other and/or additional surfaces (e.g., one or more angled surfaces, one or more curved surfaces, one or more substantially flat surfaces, etc.). Furthermore, while each retaining feature includes one tooth in the illustrated embodiment, in other embodiments, at least one retaining feature may include more teeth (e.g., 1, 2, 3, 4, 5, 6, or more). In addition, while the retaining features include a tooth/teeth in the illustrated embodiment, in other embodiments, at least one retaining feature may include another suitable engagement element, such as one or more protrusions, one or more rough surfaces, or one or more soft surfaces, among other suitable engagement elements. In further embodiments, at least one retaining feature may not include an engagement element (e.g., the surface of the retaining feature facing the respective hose may be substantially smooth and/or flat).

Furthermore, while the illustrated inlet conduit 40 includes two radial apertures spaced about 180 degrees apart from one another along the radial axis 84, and the retention system 42 includes two retaining features spaced about 180 degrees apart from one another along the radial axis 84, in further embodiments, the radial apertures/retaining features may be spaced apart by another suitable distance and/or more or fewer radial apertures/retaining features may be included. For example, in certain embodiments, the housing may have 1, 2, 3, 4, 5, 6, 7, 8, or more radial apertures extending through the inlet conduit 40, and the retention system may include a corresponding number of retaining features. In addition, the radial apertures/retaining features may be spaced apart from one another (e.g., equally spaced apart from one another) by about 30 degrees, about 60 degrees, about 120 degrees, or any other suitable distance along the circumferential axis 84.

To couple a hose to the inlet conduit 40, the hose may be aligned with an inlet conduit opening 96 and translated into the inlet conduit along the longitudinal axis 44. The angled surfaces of the teeth 94 of the retaining features may enable the hose to be inserted (e.g., by driving the retaining features outwardly along the radial axis 82 in response to contact with the hose). The hose may be inserted into the inlet conduit 40 until the hose contacts a stop 98. While the hose is disposed within the inlet conduit 40, the radial apertures and the retaining features are aligned with the hose. A hose clamp, or other suitable compression connector (e.g., cable tie, elastic connector, etc.) may then be disposed about the inlet conduit 40. In the illustrated embodiment, each retaining feature includes a protrusion 97 configured to engage the hose clamp. As the hose clamp is tightened, the hose clamp applies an inward force to the protrusions 97 of the retaining features along the radial axis 82, thereby driving the teeth of the retaining features to engage hose. As a result, movement of the hose relative to the housing is blocked.

In the illustrated embodiment, the housing 36 includes two ridges 100 extending along an outer surface of the inlet conduit 40 along the longitudinal axis 44. As illustrated, each ridge 100 includes a recess 102 configured to receive the hose clamp and to align the hose clamp with the retaining features. While the illustrated housing has two ridges and two recesses, in alternative embodiments, the housing may include more or fewer ridges (e.g., 1, 2, 3, 4, 5, 6, or more) and a corresponding number of recesses. Furthermore, in certain embodiments, the ridges and the corresponding recesses may be omitted.

In the illustrated embodiment, housing 36 is formed from a first portion 104 and a second portion 106. The two portions are coupled to one another (e.g., by an adhesive connection, by fasteners, by another suitable connector system, or a combination thereof). In certain embodiments, each portion of the housing is formed by a molding process (e.g., an injection molding process, a rotational molding process, etc.). Accordingly, for each portion, the respective radial aperture and the respective retaining feature may be formed concurrently with the portion via the molding process. Furthermore, in certain embodiments, the respective living hinge may be formed concurrently with the radial aperture and the retaining feature via the molding process. In certain embodiments, the first portion 104 and the second portion 106 may be the same as one another, thereby reducing the number of molds utilized in the molding process. While the illustrated housing 36 is formed from two portions, in alternative embodiments, the housing may be formed from more or fewer portions (e.g., 1, 2, 3, 4, 5, 6, 7, 8, or more portions).

While the radial apertures and the retention system are described above with reference to the inlet conduit, in certain embodiments, at least one outlet conduit may also include corresponding aperture(s) and a retention system. Furthermore, while the retention system disclosed herein is described with reference to a flow divider assembly, in further embodiments, the retention system may be utilized to couple a hose to other suitable hose receivers, such as a hose receiver of a metering system, a hose receiver of an air cart plenum, or any other suitable hose receiver.

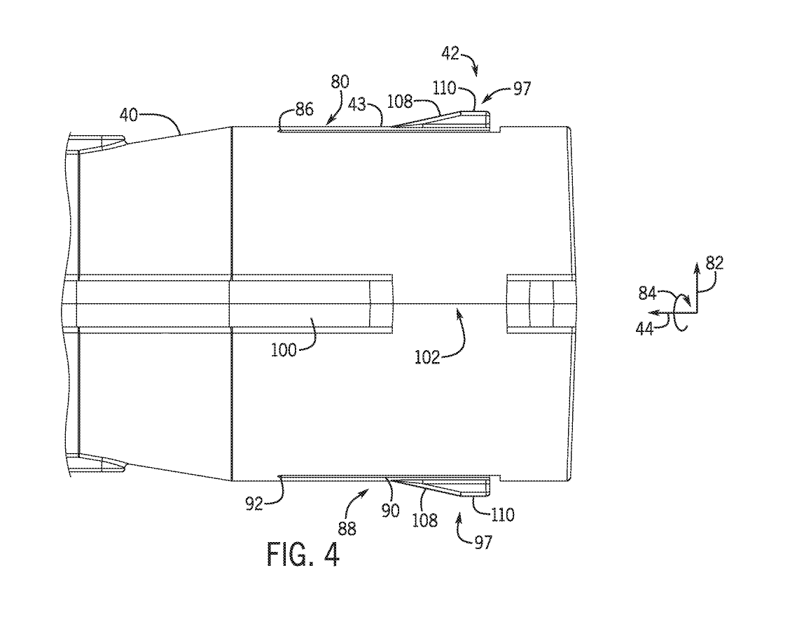

FIG. 4 is a side view of the inlet conduit 40 of the flow divider assembly of FIG. 2. As illustrated, the protrusion 97 of the first retaining feature 43 extends outwardly beyond the inlet conduit 40 along the radial axis 82. In addition, the protrusion 97 of the second retaining feature 88 extends outwardly beyond the inlet conduit 40 along the radial axis 82. As previously discussed, each protrusion 97 is configured to engage the hose clamp. Accordingly, as the hose clamp is tightened around the inlet conduit 40, the hose clamp drives the retaining features to engaged the hose via contact with the protrusions 97. Because the protrusions 97 are positioned radially outward from the inlet conduit, the hose clamp may drive the retaining features to engage the hose without applying significant pressure to the inlet conduit. As a result, the longevity of the inlet conduit may be increased (e.g., as compared to an inlet conduit without the retention system, in which a hose clamp compresses the inlet conduit around the hose to couple the flow divider assembly to the hose).

In the illustrated embodiment, each protrusion 97 includes an angled portion 108 and a flat portion 110. The hose clamp may engage the angled portion 108 and/or the flat portion 110 (e.g., based on the width of the hose clamp and/or the position of the hose clamp relative to the protrusions along the longitudinal axis 44). While each illustrated protrusion 97 includes an angled portion 108 and a flat portion 110, in other embodiments, at least one protrusion may include other and/or additional portions (e.g., one or more flat portions, one or more angled portions, one or more curved portions, etc.). In further embodiments, at least one protrusion may have a single portion (e.g., a single flat portion, a single angled portion, a single curved portion, etc.). In other embodiments, the protrusion(s) may be omitted, and a body of the retaining feature may extend radially outward beyond the inlet conduit, thereby enabling the hose clamp to engage the retaining feature body.

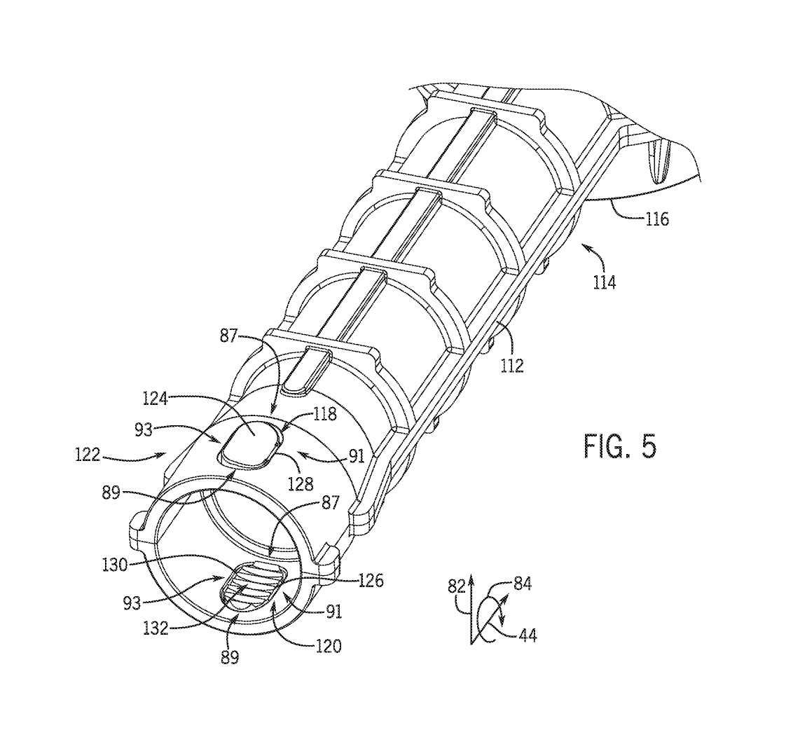

FIG. 5 is a perspective view of an inlet conduit 112 of another embodiment of a flow divider assembly 114 that may be employed within the product distribution system of FIG. 1. In the illustrated embodiment, a housing 116 of the flow divider assembly 114 includes a first radial aperture 118 and a second radial aperture 120. Each radial aperture extends through the inlet conduit 112 along the radial axis 82. In addition, the flow divider assembly 114 includes a retention system 122 having a first retaining feature 124 and a second retaining feature 126. The first retaining feature 124 is configured to move within the first aperture 118, and the second retaining feature 126 is configured to move within the second aperture 120. In addition, each retaining feature is movably coupled to the inlet conduit 112, each retaining feature is configured to engage the respective hose in response to a radially inward force applied to the retaining feature, and each retaining feature is configured to block movement of the respective hose relative to the housing while engaged.

In the illustrated embodiment, each radial aperture and each retaining feature has curved longitudinal ends and substantially straight circumferential ends, thereby establishing a capsule-shape. However, in other embodiments, such as the embodiment disclosed above with reference to FIGS. 2-4, each longitudinal end of the radial aperture/retaining feature may be substantially straight. In further embodiments, the radial aperture(s) and/or retaining feature(s) may have other shapes, such as round, elliptical, or polygonal, among other suitable shapes. In addition, certain radial aperture(s) and/or retaining feature(s) may include one or more straight ends/sides, one or more curved ends/sides, one or more angled ends/sides, or a combination thereof, among other suitable ends/sides.

In the illustrated embodiment, the first retaining feature 124 is movably coupled to the inlet conduit 112 by a first living hinge 128, and the second retaining feature 126 is movably coupled to the inlet conduit 112 by a second living hinge 130. The living hinges are configured to enable each retaining feature to move (e.g., rotate about the longitudinal axis 44) between the illustrated receiving position that enables the respective hose to be inserted into the inlet conduit 112 and a locking position, in which the retaining feature is engaged with the respective hose, that blocks movement of the respective hose relative to the housing 116. The illustrated first living hinge 128 is positioned at the first circumferential end 91 of the first retaining feature 124 (e.g., first end of the first retaining feature 124 along the circumferential axis 84). In addition, the illustrated second living hinge 130 is positioned at the second circumferential end 93 of the second retaining feature 126 (e.g., second end of the second retaining feature 126 along the circumferential axis 84).

In the illustrated embodiment, each retaining feature includes an engagement element, such as the illustrated angled teeth 132, configured to depress the hose while the retaining feature is engaged. In the illustrated embodiment, each angled tooth includes an angled surface configured to facilitate insertion of the respective hose into the inlet conduit 112. In addition, each angled tooth includes a substantially flat surface that extends to the angled surface, thereby forming a peak. The peak is configured to engage the respective hose to couple the respective hose to the inlet conduit 112 while the retaining feature is engaged (e.g., while the retaining feature is in the locking position). In the illustrated embodiment, each retaining feature includes seven teeth. However, in other embodiments, at least one retaining feature may include more or fewer teeth (e.g., 1, 2, 3, 4, 5, 6, 7, 8, 9, 10, 11, 12, or more).

While the radial apertures and the retention system are described above with reference to the inlet conduit, in certain embodiments, at least one outlet conduit may also include corresponding aperture(s) and a retention system. Furthermore, while the retention system disclosed herein is described with reference to a flow divider, in further embodiments, the retention system may be utilized to couple a hose to other suitable hose receivers, such as a hose receiver of a metering system, a hose receiver of an air cart plenum, or any other suitable hose receiver.

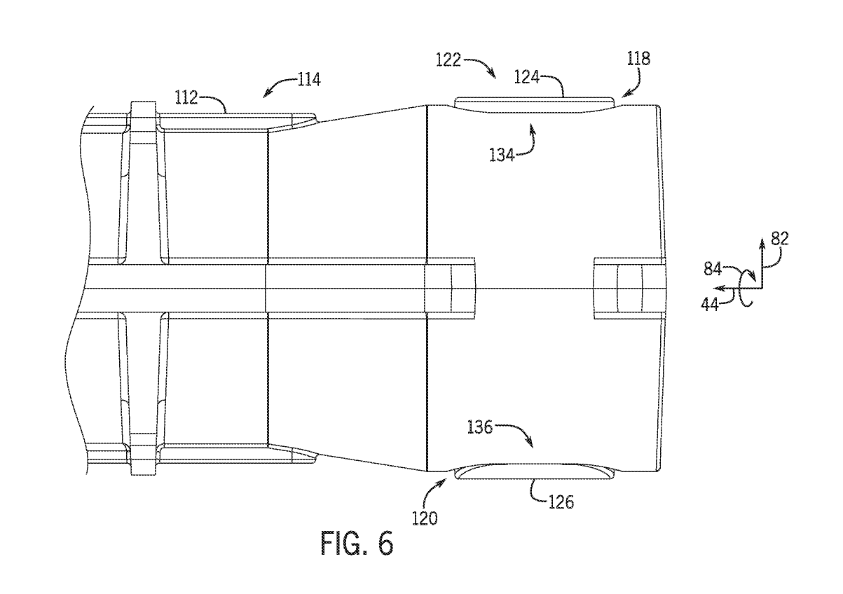

FIG. 6 is a side view of the inlet conduit 112 of the flow divider assembly 114 of FIG. 5. In the illustrated embodiment, the first retaining feature 124 extends outwardly beyond the inlet conduit 112 along the radial axis 82. In addition, the second retaining feature 126 extends outwardly beyond the inlet conduit 112 along the radial axis 82. Furthermore, the inlet conduit 112 has a first recess 134 configured to enable the first retaining feature 124 to move inwardly toward the hose along the radial axis 82, and the inlet conduit 112 has a second recess 136 configured to enable the second retaining feature 126 to move inwardly toward the hose along the radial axis 82. While each recess is curved in the illustrated embodiment, in other embodiments, at least one recess may be formed from one or more straight/angled surfaces. Furthermore, while the illustrated embodiment includes raised retaining features and corresponding recesses, in other embodiments, at least one of the recesses may be omitted (e.g., in embodiments in which the corresponding retaining feature is raised). In further embodiments, the outward radial extent of at least one retaining feature may be substantially equal to the outward radial extent of the inlet conduit 112 (e.g., in embodiments which include a corresponding recess).

As the hose clamp is tightened around the inlet conduit 112, the hose clamp drives the retaining features to engage the hose via contact with the retaining features. Because the retaining features are positioned radially outward from the inlet conduit and/or the recesses enable the retaining features to move radially inward relative to the inlet conduit, the hose clamp may drive the retaining features to engage the hose without applying significant pressure to the inlet conduit. As a result, the longevity of the inlet conduit may be increased (e.g., as compared to an inlet conduit without the retention system, in which a hose clamp compresses the inlet conduit around the hose to couple the flow divider to the hose).

In certain embodiments, one or more features of the embodiment disclosed with reference to FIGS. 2-4 may be used in any suitable combination with one or more other features of the embodiment disclosed with reference to FIGS. 5-6. For example, in certain embodiments, at least one radial aperture and at least one corresponding retaining feature may have a substantially rectangular shape, and a living hinge, which may be formed concurrently with the housing portion and the retaining feature via a molding process, may be positioned on a circumferential side of the retaining feature. Furthermore, in certain embodiments, at least one radial aperture and at least one corresponding retaining feature may have a substantially rectangular shape, and the retaining feature may include multiple teeth. In further embodiments, at least one radial aperture and at least one corresponding retaining feature may have a substantially rectangular shape, and the retaining feature may extend radially outward from the inlet conduit and/or the outlet conduit may have a recess configured to enable radially inward movement of the retaining feature.

While only certain features have been illustrated and described herein, many modifications and changes will occur to those skilled in the art. It is, therefore, to be understood that the appended claims are intended to cover all such modifications and changes as fall within the true spirit of the disclosure.

1. A hose receiver, comprising:
a housing having a longitudinal conduit and a radial aperture extending through the longitudinal conduit, wherein the longitudinal conduit is configured to receive a hose, and the radial aperture is positioned to align with the hose while the hose is disposed within the longitudinal conduit; and
a retention system comprising a retaining feature, wherein the retaining feature is movably coupled to the longitudinal conduit and configured to move within the radial aperture, the retaining feature is configured to engage the hose in response to a radially inward force applied to the retaining feature, and the retaining feature is configured to block movement of the hose relative to the housing while engaged.

2. The hose receiver of claim 1, wherein the retention system comprises a hose clamp disposed about the longitudinal conduit and configured to apply the radially inward force to the retaining feature.

3. The hose receiver of claim 2, wherein the housing has a ridge extending along an outer surface of the longitudinal conduit, and the ridge has a recess configured to receive the hose clamp and to align the hose clamp with the retaining feature.

4. The hose receiver of claim 1, wherein the retaining feature comprises an engagement element configured to depress the hose while the retaining feature is engaged.

5. The hose receiver of claim 4, wherein the engagement element comprises at least one angled tooth.

6. The hose receiver of claim 1, wherein the housing has a second radial aperture extending through the longitudinal conduit, and the second radial aperture is positioned to align with the hose while the hose is disposed within the longitudinal conduit; and
wherein the retention system comprises a second retaining feature movably coupled to the longitudinal conduit and configured to move within the second radial aperture, the second retaining feature is configured to engage the hose in response to a second radially inward force applied to the second retaining feature, and the second retaining feature is configured to block movement of the hose relative to the housing while engaged.

7. The hose receiver of claim 6, wherein the second radial aperture and the second retaining feature are positioned about 180 degrees from the radial aperture and the retaining feature along a circumferential axis.

8. The hose receiver of claim 1, wherein the retaining feature is movably coupled to the longitudinal conduit by a living hinge.

9. A flow divider assembly comprising:
a housing having an inlet conduit configured to receive an agricultural product, a first outlet conduit configured to discharge the agricultural product, and a second outlet conduit configured to discharge the agricultural product, wherein each of the inlet conduit, the first outlet conduit, and the second outlet conduit is configured to receive a respective hose;
a valve disposed within the housing, wherein the valve is configured to selectively direct the agricultural product from the inlet conduit to the first outlet conduit, to the second outlet conduit, or a combination thereof; and
a retaining system comprising a retaining feature;
wherein at least one conduit of the inlet conduit, the first outlet conduit, and the second outlet conduit has a respective radial aperture extending through the at least one conduit, the respective radial aperture is positioned to align with the respective hose while the respective hose is disposed within the at least one conduit, the retaining feature is movably coupled to the at least one conduit and configured to move within the respective radial aperture of the at least one conduit, the retaining feature is configured to engage the respective hose in response to a radially inward force applied to the retaining feature, and the retaining feature is configured to block movement of the respective hose relative to the housing while engaged.

10. The flow divider assembly of claim 9, wherein the retention system comprises a hose clamp disposed about the at least one conduit and configured to apply the radially inward force to the retaining feature.

11. The flow divider assembly of claim 10, wherein the housing has a ridge extending along an outer surface of the at least one conduit, and the ridge has a recess configured to receive the hose clamp and to align the hose clamp with the retaining feature.

12. The flow divider assembly of claim 9, wherein the retaining feature comprises an engagement element configured to depress the respective hose while the retaining feature is engaged.

13. The flow divider assembly of claim 12, wherein the engagement element comprises at least one angled tooth.

14. The flow divider assembly of claim 9, wherein the retaining feature is movably coupled to the at least one conduit by a living hinge.

15. The flow divider assembly of claim 14, wherein the living hinge extends along a circumferential axis of the at least one conduit from the housing to the retaining feature.

16. A method of manufacturing a hose receiver, comprising:
forming a housing having a longitudinal conduit and a radial aperture extending through the longitudinal conduit, wherein the longitudinal conduit is configured to receive a hose, and the radial aperture is positioned to align with the hose while the hose is disposed within the longitudinal conduit; and
forming a retaining feature of a retention system, wherein the retaining feature is movably coupled to the longitudinal conduit and configured to move within the radial aperture, the retaining feature is configured to engage the hose in response to a radially inward force applied to the retaining feature, and the retaining feature is configured to block movement of the hose relative to the housing while engaged.

17. The method of claim 16, wherein at least a portion of the housing having the radial aperture and the retaining feature are formed concurrently via a molding process.

18. The method of claim 17, comprising forming a living hinge that movably couples the retaining feature to the longitudinal conduit, wherein the living hinge is formed concurrently with the portion of the housing and the retaining feature via the molding process.

19. The method of claim 16, wherein the retaining feature comprises an engagement element configured to depress the hose while the retaining feature is engaged.

20. The method of claim 19, wherein the engagement element comprises at least one angled tooth.
